(19) United States
(12) Patent Application Publication
(10) Pub. No.: US 2004/0240132 A1
(43) Pub. Date: Dec. 2, 2004

(54) Hid dimming system interface box

(76) Inventor: Christopher A. Hudson, Blacksburg, VA (US)

Correspondence Address: Roylance, Abrams, Berdo & Goodman, L.L.P., 1300 19th Street, Suite 600, Washington, DC, 20036, US

(21) Appl. No.: 10/448,428

(22) Filed: May 30, 2003

(51) Int. Cl. H02H 3/00

(52) U.S. Cl. 361/62

(57) ABSTRACT

An interface apparatus for interfacing an AC power source, a control panel and a luminaire. The interface apparatus includes a input/output port that is adapted to receive a communication signal from the control panel and transmit the communication signal to the luminaire and to a second interface apparatus; and a power cord adapter, that is adapted to receive an AC power signal from the power source and provide the AC power signal to the luminaire and to the second interface apparatus. In another embodiment of the present invention, a luminaire provides an input/output port that is adapted to receive a communication signal from a control panel via the input port and transmit the communication signal to another luminaire via the output port.

### BACKGROUND OF THE INVENTION

1. Field of the Invention

The present invention relates in general to an interface box and in particular to an apparatus for wiring a control network and AC network to a lighting system.

2. Description of the Related Art

Currently luminaires are wired from a junction box located at a central location and serve as an interface between an AC power source and the luminaires and the control panel which contains the microprocessor to address each luminaire individually, for example, to dim a particular luminaire. The communication wiring is routed separately from the AC power source due to UL CSA certification requirements.

When a maintenance problem occurs with a luminaire, a technician has to go to the junction box and determine which wire goes to the malfunctioning luminaire. The conventional practice is to connect a test set at the malfunctioning luminaire and, based on a tone sent by the test set, locate the wire associated with the malfunctioning luminaire at the junction box.

This process is time consuming and can lead to errors where the wrong luminaire is disconnected. This can result in injury if the luminaire that was disconnected was being used by a person performing a simple job function, for example, using power tools, when the illumination in the room is extinguished. In addition, people usually find it irritating to be in complete darkness unexpectedly.

As the number of luminaires in a system increases, the likelihood for error on a technician's part also increases. Limiting the number of luminaires to a particular junction box reduces the maintenance problems in terms of locating the wiring associated with a malfunctioning luminaire among the other wiring in the junction box, but it also increases the cost of doing business because more junction boxes have to be purchased. In addition, the complexity of determining the correct junction box has also increased. For example, if there were one junction box to a room and now there is three, the technician would have to check all three junction boxes for the wiring of the malfunctioning luminaire. Since the wiring from the luminaire is usually run in the ceiling, the technician would not be able to look at the malfunctioning luminaire and tell by sight which junction box was associated with the malfunctioning luminaire.

Therefore, a need exists for interfacing a control panel, AC power supply and luminaires so that maintenance problems can be resolved quickly and easily.

### SUMMARY OF THE INVENTION

According to an aspect of the present invention, an interface apparatus provides an interface among an AC power source, a control panel and a luminaire. The interface apparatus includes an input/output port that is adapted to receive a communication signal from the control panel and transmit the communication signal to the luminaire and to a second interface apparatus; and a power cord adapter, that is adapted to receive an AC power signal from the power source and provide the AC power signal to the luminaire and to the second interface apparatus.

According to another aspect of the present invention, a luminaire provides an input/output port that is adapted to receive a communication signal from a control panel via the input port and transmit the communication signal to another luminaire via the output port.

### BRIEF DESCRIPTION OF THE DRAWINGS

These and other aspects, advantages and novel features of the invention will be more readily appreciated from the following detailed description when read in conjunction with the accompanying drawings, in which:

FIG. 1 is a front view illustrating an example of a schematic of the interface box in accordance with a first embodiment of the present invention;

FIG. 2 is a block diagram illustrating an example of a dimming system using the interface box in accordance with the first embodiment of the present invention;

FIG. 3 is a perspective view illustrating an example of a control interface in accordance with a second embodiment of the present invention; and

FIG. 4 is a front view illustrating an example of an interface box in accordance with a first embodiment of the present invention.

### DETAILED DESCRIPTION OF THE PREFERRED EMBODIMENTS

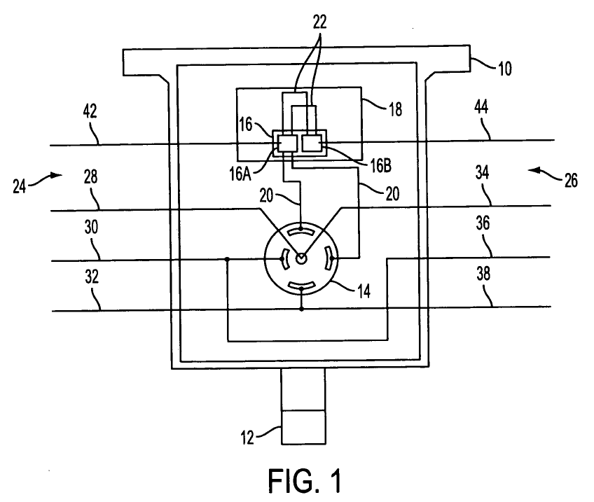

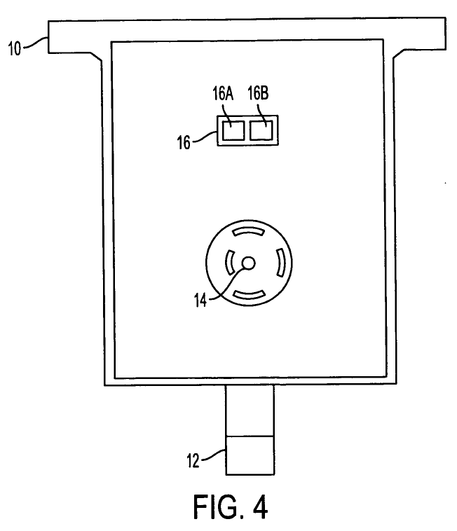

FIG. 1 is a front view illustrating an example of a schematic of the interface box in accordance with a first embodiment of the present invention and is similar to FIG. 4. The interface box comprises a hooking member 12, a twist off receptacle 14, and a data port 16. Data port 16 further comprises an input port 16A and an output port 16B. In an embodiment of the present invention data port is a two wire connection, for example, an RJ11 jack. In another embodiment of the present invention data port 16 is a four wire connection, for example, an RJ45 jack. The four wire connection can be used to convey additional commands to a luminaire from a control panel, for example, off, on, high and low as opposed to only off and on in a two wire connection.

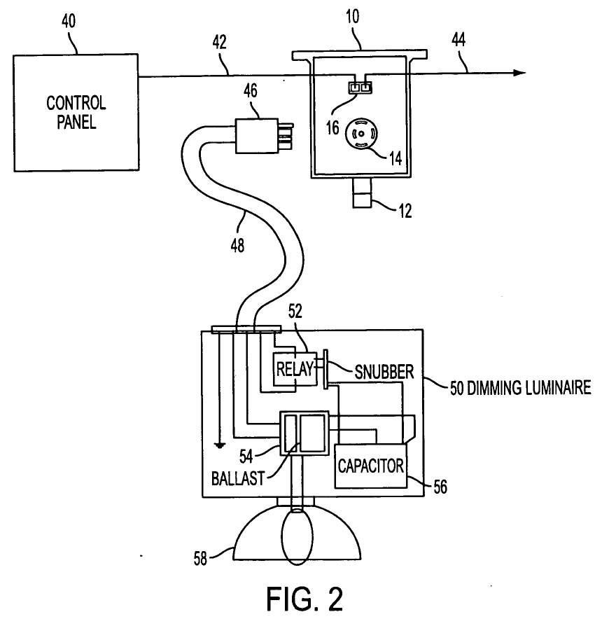

The interface box 10 operates in the following manner. A control panel 40 (see FIG. 2) is connected to the interface box 10 via an input communications line 42. The input communications line 42 is connected to the input port 16A. An output communications line 44 communications line is connected to the output port 16B and is provided to another junction box (not shown). An AC input power line 24 comprising an input hot conductor 28, an input ground conductor 30 and an input neutral conductor 32 from an AC source (not shown) is connected to the back of twist off receptacle 14 (see FIG. 1). An AC output power line 26 comprising output hot conductor 34, output ground conductor 36 and output neutral conductor 38 is provided from twist off receptacle 14 to another junction box (not shown). Internal communications wiring 20 connect the data port 16 to the twist off receptacle 14. Data port connecting wiring 22 connects input port 16A to output port 16B.

Referring now to FIG. 2, luminaire 50 comprises a relay 52, a ballast 54, a capacitor 56 and a lamp 58. Luminaire 50 operates in a conventional manner. Therefore, the operation of luminaire 50 will not be discussed except with respect to the novelty of interface box 10. Luminaire 50 is connected to interface box 10 via a cord 48 and plug 46. Although the plug 46 and twist off receptacle 14 are shown as having a five prong and five slot connection, those skilled in the art will appreciate that the number of prongs and slots can be varied without departing from the scope of the present invention. For example, a two wire or three wire plug can be used with a two wire or three wire twist off receptacle. Data port 16 would not be needed since the two wire or four wire connection would just contain a hot conductor, neutral conductor and/or ground conductor. The number of slots and prongs used varies typically from two to six.

Communication commands can be conveyed from the control panel 40 to the luminaire 50 using input communication line 42, the data port 16, plug 46 and cord 48. For example, the lamp 58 can be dimmed remotely from the control panel 40 using the communications channel, which is established through the cord 48 and communication line 42.

Hooking member 12 can be used to attach the interface box 10 to the luminaire 50. This eliminates the need for a technician to attach the interface box 10 to the luminaire 50 with screws or other permanent attaching means. Hooking member 12 also allows interface box 10 to be portable and be used on different luminaires if the need arises to relocate the interface box. In an embodiment of the present invention, the interface box 10 can be used for testing new installations of lighting systems. That is, the interface box 10 can be used to confirm accurate wiring of the luminaires on a new installation and then removed.

As described, twist off receptacle 14 allows the AC power line and the communications line from the control panel 40 to be daisy chained to other interface boxes. Thus, a malfunctioning luminaire 50 can be operated on and disconnected from the interface box 10 without affecting the operation of other luminaires. All that is required is that the malfunctioning luminaire be disconnected from interface box 10 via cord 48 and plug 46. The path of the AC power source continues via AC output line 26 and thus prevents the disruption of power to other luminaires.

The limitation on how many interface boxes that can be daisy chained is limited by the amount of current supplied by the control panel 40 and the size of the communication wire used to connect the interface box 10 with the control panel 40. There is a minimum voltage required by the luminaire 50 to activate. Both the total current and wire size affect the amount that the voltage drops in the communication wire.

Interface box 10 meets the UL CSA certification requirement that the AC voltage in the wires does not exceed 600 volts. Therefore, there is no interference between the power line and the data line.

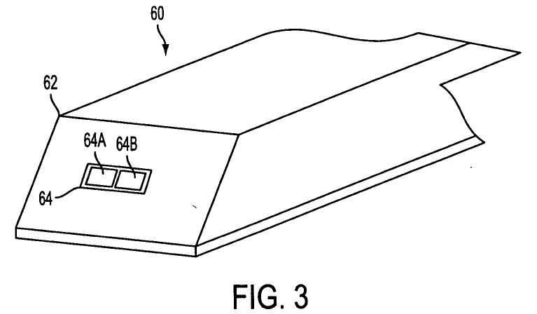

FIG. 3 is a perspective view illustrating an example of a control interface in accordance with a second embodiment of the present invention. Specifically, FIG. 3 illustrates a luminaire 60 having a data port 64 mounted in the housing 62 of the luminaire 60. The luminaire 60 functions in a manner similar to interface box 10. However, the power is brought into luminaire 60 in a conventional manner. A cord and plug is not used. Instead, a standard power connection from a junction box or conduit is used. The daisy chaining occurs at each luminaire. For example, the power source is connected to a luminaire and continues onto the next luminaire. Daisy chaining also occurs at data port 64. In data port 64A receives a communication line 42 from a control panel 40 or from another luminaire having the same data port as in data port 64 or data port 16. Out data port 64B can be used to extend the communication channel 44 to another luminaire or the communication channel can terminate at luminaire 60.

Those skilled in the art can now appreciate from the foregoing description that the broad teachings of the present invention can be implemented in a variety of forms. Therefore, while this invention can be described in connection with particular examples thereof, the true scope of the invention should not be so limited since other modifications will become apparent to the skilled practitioner upon a study of the drawings, specification and following claims.

What is claimed is:

1. An interface apparatus for interfacing an AC power source, a control panel and a luminaire, said interface apparatus comprises:
a input/output port, adapted to receive a communication signal from said control panel and transmit the communication signal to said luminaire and to a second interface apparatus; and
a power cord adapter, adapted to receive an AC power signal from said power source and provide said AC power signal to said luminaire and to said second interface apparatus.

2. The interface apparatus of claim 1, further comprising:
a hooking member, adapted to attach said interface apparatus to said luminaire.

3. The interface apparatus of claim 1, wherein said interface apparatus is portable.

4. The interface apparatus of claim 1, wherein said input/output port transmits and receives at least one of a data signal and an analog signal.

5. The interface apparatus of claim 1, wherein said input/output port comprises at least one of a two wire connection and a four wire connection.

6. The interface apparatus of claim 1, wherein said input/output port comprises at least one of an RJ11 jack and an RJ45 jack.

7. The interface apparatus of claim 1, wherein said luminaire receives power from said interface box via a cord and a plug.

8. The interface apparatus of claim 7, wherein said cord comprises at least one of two wires, three wires, four wires, five wires and six wires.

9. The interface apparatus of claim 7 wherein said plug comprises at least one of two prongs, three prongs, four prongs, five prongs and six prongs.

10. The interface apparatus of claim 1, wherein said power adapter comprises at least one of two slots, three slots, four slots, five slots and six slots.

11. The interface apparatus of claim 1, wherein said interface apparatus allows daisy chaining of other luminaires.

12. A luminaire comprising:
an input/output port, adapted to receive a communication signal from a control panel via said input port and transmit the communication signal to another luminaire via said output port.

13. The luminaire of claim 12, wherein said input/output port is disposed in a housing of said luminaire.

14. The luminaire of claim 12, wherein said input output port comprises at least one of a two wire and four wire jack.

15. The luminaire of claim 12, wherein said input/output port comprises at least one of an RJ11 jack and an RJ45 jack.
